(19) United States
(12) Patent Application Publication
(10) Pub. No.: US 2026/0248679 A1
(43) Pub. Date: Aug. 27, 2026

(54) INFLATABLE MASSAGE BACKREST

(71) Applicant: XIAMEN COMFIER TECHNOLOGY CO.,LTD., Fujian (CN)

(72) Inventors: Jianqing LI, Fujian (CN); Xin WU, Fujian (CN); Guoyan OU, Fujian (CN)

(21) Appl. No.: 18/832,118

(22) PCT Filed: Aug. 11, 2023
(86) PCT No.: PCT/CN2023/112508

§ 371 Date: Mar. 11, 2026

(30) Foreign Application Priority Data
Aug. 15, 2022 (CN) 202210975672.9

(51) Int. Cl. A61H 9/00; A61H 7/00

(52) U.S. Cl. CPC A61H 9/005; A61H 7/007; A61H 2201/0103; A61H 2201/0149; A61H 2201/1409; A61H 2201/1623; A61H 2201/1669; A61H 2203/0431; A61H 2205/081

(57) ABSTRACT

Provided is an inflatable massage backrest, including: a backrest cloth cover (1), a massager (2), and an air bag (3). The massager (2) is fixedly arranged in a cavity (11) enclosed by the backrest cloth cover (1). The air bag (3) is aligned with massage surfaces (20) of the massager (2). The air bag (3) is fixedly to the backrest cloth cover (1). Through the air bag (3) which aligns with the massage surfaces (20) of the massager (2), the air bag (3) can buffer and thus adjust the massaging power of the massager (2), so that the massaging power of the massager (2) on user is reduced, thereby improving the massage comfort.

### TECHNICAL FIELD

The present invention relates to the technical field of backrests, in particular to an inflatable massage backrest.

### BACKGROUND OF THE INVENTION

Due to rapid development of society, more and more office workers spend long hours working in the office, which leads to back and waist pain. To alleviate and relax the back and waist of office workers through massage, backrests equipped with massage devices have been developed.

A common backrest with a massage device comprises a massage device and a backrest covering cloth. The massage device is fixed within the backrest covering cloth, and the massage heads of the massage device act directly on the backrest covering cloth to massage user's back and waist. The massage heads act on the human body through a covering cloth of an ordinary thickness. Because the massage power of the massage heads of the massage device is difficult to adjust, user often experiences excessively strong massaging power during use of a backrest equipped with such a massage device, thereby resulting in reduced comfort during massage.

### BRIEF SUMMARY OF THE INVENTION

It is an object of the present invention to provide an inflatable massage backrest that can enhance user's comfort during massage.

To attain the above object, the present invention provides the following technical solutions:

An inflatable massage backrest, comprising a backrest covering cloth, a massager, and an airbag; the massager is fixed within a cavity enclosed by the backrest covering cloth; the airbag is aligned with massage surfaces of the massager, and the airbag is fixed to the backrest covering cloth.

The inflatable massage backrest further comprises a backrest overlay; the backrest overlay is detachably connected to the backrest covering cloth, and the airbag is fixedly disposed inside the backrest overlay.

The backrest overlay is adhered to the backrest covering cloth through hook and loop fasteners.

The airbag is provided with an inflation nozzle; the inflation nozzle extends out of the backrest overlay from a surface of the backrest overlay facing towards the backrest covering cloth when the backrest overlay is in an in-use position.

The inflatable massage backrest further comprises a pillow; the pillow is detachably connected to an outer side of the backrest overlay.

The airbag is fixedly disposed inside the backrest covering cloth.

The airbag is provided with an inflation nozzle; the inflation nozzle extends outwardly out of an outer side of backrest covering cloth.

The inflatable massage backrest further comprises a pillow; the pillow is detachably connected to the outer side of the backrest covering cloth.

The pillow is detachably connected to the outer side of the backrest covering cloth through hook and loop fasteners.

The massager comprises a movable massage mechanism, at least one rail, and a massager housing; said at least one rail is fixed on the massager housing, and the movable massage mechanism is movably mounted on said at least one rail so as to be movable along an up-down direction of the massager; the movable massage mechanism is provided with a plurality of massage heads; surfaces of the plurality of massage heads where massage is applied are said massage surfaces.

According to the technical solutions provided by the present invention, through the provision of the airbag which can be fixed to the backrest covering cloth and which aligns with the massage surfaces of the massager, the airbag will buffer and thus adjust the massaging power of the massager when the present invention is used for massaging user's waist and back. Specifically, the massaging power exerted by the massager on the user will be reduced, thereby enhancing massage comfort. Moreover, the airbag can be inflated with different amount of air to provide different buffering performance against the massaging power of the massager, and thus adjusting the massaging power of the massager, thereby meeting different users' needs for different massaging power.

### BRIEF DESCRIPTION OF THE DRAWINGS

FIG. 1 is a schematic diagram of the structure of the present invention;

FIG. 2 is a sectional view according to an embodiment of the present invention;

FIG. 3 is a sectional view according to another embodiment of the present invention; and

FIG. 4 is a schematic diagram of an airbag of the present invention.

### DESCRIPTION OF REFERENCE NUMERALS

Backrest covering cloth 1 Cavity 11 Massager 2
Massage surface 20 Movable massage mechanism 21 Rail 22
Massager housing 23 Massage head 211 Chamber 231
Airbag 3 Inflation nozzle 31 Backrest overlay 4
Hook and loop fastener 5 Pillow 6.

### DETAILED DESCRIPTION OF THE INVENTION

Further details of the present invention are described below in conjunction with the accompanying drawings and specific embodiments.

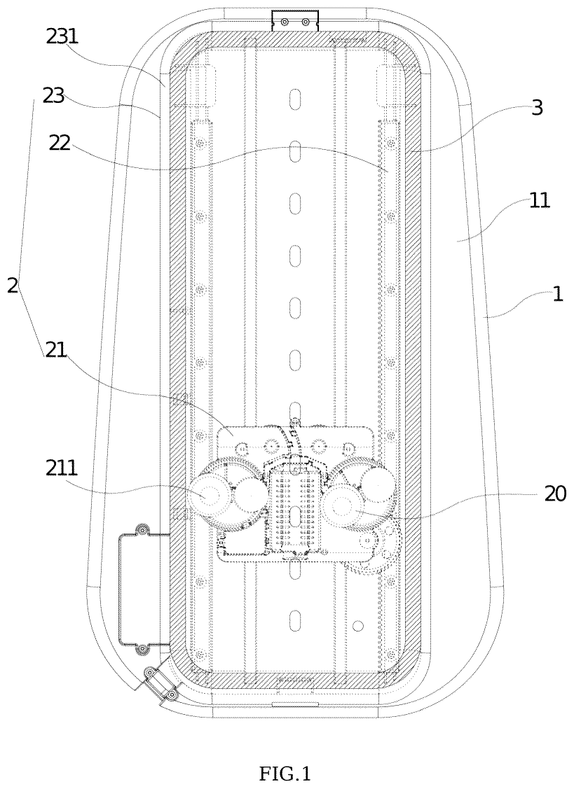

Referring to FIGS. 1 to 4, an inflatable massage backrest is disclosed according to the present invention. The inflatable massage backrest comprises a backrest covering cloth 1, a massager 2, and an airbag 3; the massager 2 is fixed within a cavity 11 enclosed by the backrest covering cloth 1; the airbag 3 is aligned with massage surfaces 20 of the massager 2, and the airbag 3 is fixed to the backrest covering cloth 1.

Therefore, in the present invention, through the provision of the airbag 3 which can be fixed to the backrest covering cloth 1, which aligns with the massage surfaces 20 of the massager 2, and which is positioned in front of the massage surfaces 20, the airbag 3 will buffer and thus adjust the massaging power of the massager 2 when the present invention is used for massaging user's waist and back. Specifically, the massaging power exerted by the massager 2 on the user will be reduced, thereby enhancing massage comfort. Moreover, the airbag 3 can be inflated with different amount of air to provide different buffering performance against the massaging power of the massager 2, and thus adjusting the massaging power of the massager 2, thereby meeting different users' needs for different massaging power.

A simplified structure of the present invention is illustrated in FIG. 1 (where the massager 2 inside the backrest covering cloth 1 unable to be seen through in actual use is drawn in broken lines), where the massager 2 may comprise a movable massage mechanism 21, at least one rail 22, and a massager housing 23. Said at least one rail 22 is fixed on the massager housing 23, and the movable massage mechanism 21 is movably mounted on said at least one rail 22 so as to be movable along an up-down direction of the massager 2. Said at least one rail 22 may comprises two rails 22 parallel and spaced apart from each other, and two sides of the movable massage mechanism 21 are mounted to the two rails 22 respectively, and the two rails 22 and the movable massage mechanism 21 are installed within a chamber 231 enclosed by the massager housing 23. The movable massage mechanism 21 is provided with a plurality of massage heads 211 spaced apart from one another. The massage heads 211 are designed to achieve different movements such as rotation and undulation independently or in cooperation with one another to create actions like kneading and tapping. Surfaces of the plurality of massage heads 211 where massage is applied are said massage surfaces 20, and the back or waist of a user can be placed against the massage surfaces 20 for massage. The movable massage mechanism 21 may be mounted to said at least one rail 22 through rack and gear engagement, thus allowing the movable massage mechanism 21 to be mounted to said at least one rail 22 in movable manner along the up-down direction of the massager 2.

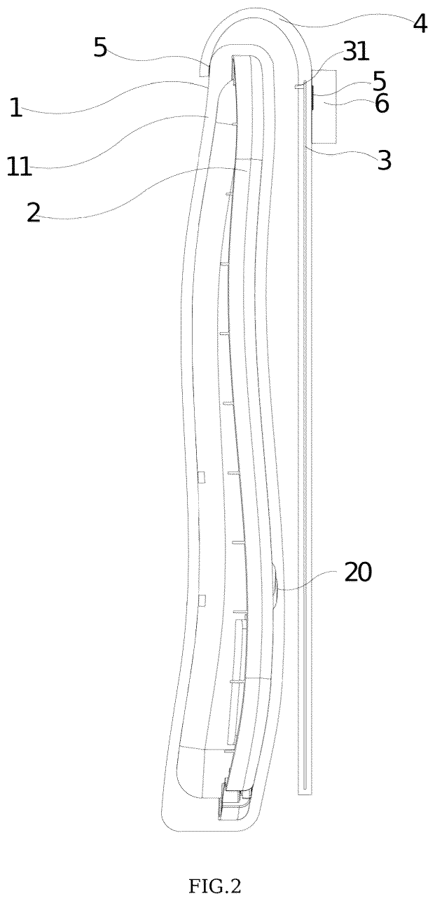

Referring to FIG. 2, according to an embodiment of the present invention, the inflatable massage backrest of the present invention further comprises a backrest overlay 4. The backrest overlay 4 is detachably connected to the backrest covering cloth 1, and the airbag 3 is fixedly disposed inside the backrest overlay 4. This allows the airbag 3 to be detachably connected to the backrest covering cloth 1, enhancing the flexibility of use of the present invention and meeting the need for users to choose whether to use the airbag 3 or not.

To facilitate the detachable connection of the backrest overlay 4, the backrest overlay 4 may be adhered to the backrest covering cloth 1 through but not limited to hook and loop fasteners 5. The backrest overlay 4 may also be detachably connected to the backrest covering cloth 1 by other structures that allow detachable connection.

Furthermore, to facilitate adjustment of an amount of air used for inflation of the airbag 3, the airbag 3 may be provided with an inflation nozzle 31. The inflation nozzle 31 extends out of the backrest overlay 4 from a surface of the backrest overlay 4 facing towards the backrest covering cloth 1 when the backrest overlay 4 is in an in-use position.

In addition, for the convenience of resting user's head, the inflatable massage backrest of the present invention may also comprise a pillow 6, The pillow 6 is detachably connected to an outer side of the backrest overlay 4. According to an embodiment, the pillow 6 is detachably connected to the outer side of the backrest overlay 4 through but not limited to hook and loop fasteners 5. The pillow 6 may also be integrally formed with the backrest overlay 4.

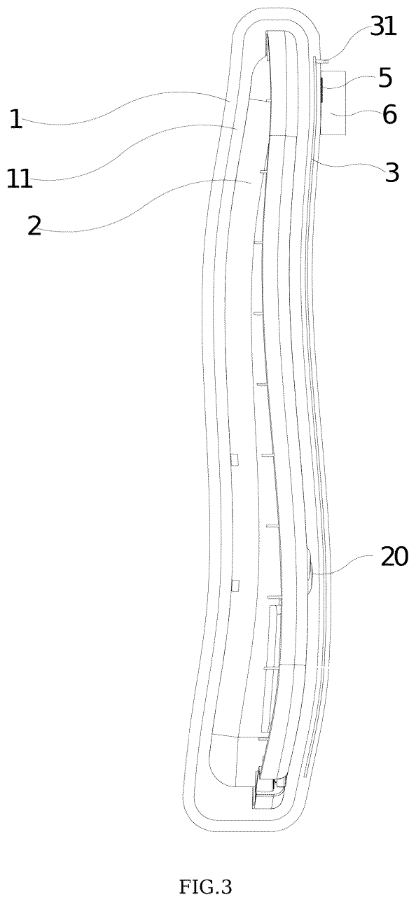

Referring to FIG. 3, according to another embodiment of the present invention, a simplified structure of the present invention is shown, wherein the airbag 3 may be directly fixed inside the backrest covering cloth 1.

Furthermore, to facilitate adjustment of an amount of air used for inflating the airbag 3, the airbag 3 is provided with an inflation nozzle 31. The inflation nozzle 31 extends outwardly out of an outer side of backrest covering cloth 1.

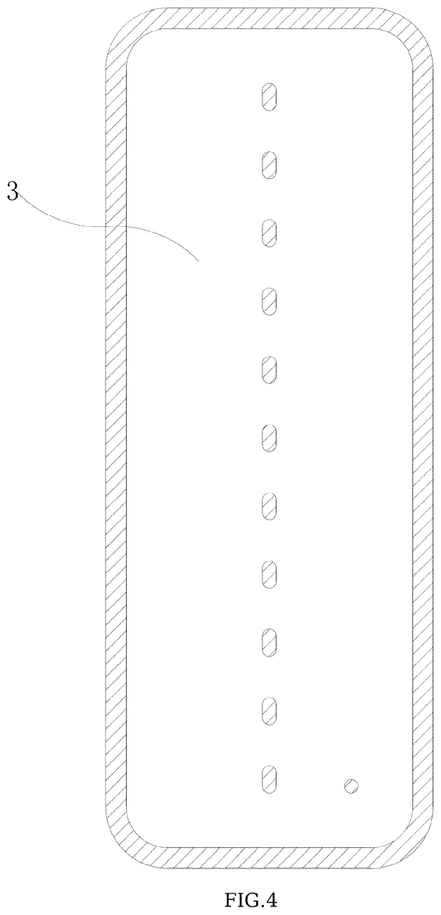

Referring to FIG. 4, the airbag 3 may form an inflatable cushion in shape of a board positioned within the outer side of the backrest covering cloth 1 and positioned in front of the movable massage mechanism 21, aligning with the massage surfaces 20 formed by the plurality of massage heads 211. The airbag 3 may cover an entire track of movement of the movable massage mechanism 21. When a user leans against the outer side of the backrest covering cloth 1 for massage, the airbag 3 can buffer and thus adjust the massaging power of the massager 2.

In addition, for the convenience of resting user's head, the inflatable massage backrest of the present invention may also comprise a pillow 6. The pillow 6 is detachably connected to the outer side of the backrest covering cloth 1. According to an embodiment, the pillow 6 is detachably connected to the outer side of the backrest covering cloth 1 through but not limited to hook and loop fasteners 5. The pillow 6 may also be integrally formed with the backrest covering cloth 1.

The above descriptions are merely the preferred embodiments of the present invention and are not intended to limit the technical scope of the present invention. Therefore, any changes or modifications made in accordance with the claims and the specification of the present invention shall fall within the scope of the patent coverage of the present invention.

1: An inflatable massage backrest, comprising a backrest covering cloth, a massager, and an airbag; the massager is fixed within a cavity enclosed by the backrest covering cloth; the airbag is aligned with massage surfaces of the massager, and the airbag is fixed to the backrest covering cloth.

2: The inflatable massage backrest of claim 1, further comprising a backrest overlay; the backrest overlay is detachably connected to the backrest covering cloth, and the airbag is fixedly disposed inside the backrest overlay.

3: The inflatable massage backrest of claim 2, wherein the backrest overlay is adhered to the backrest covering cloth through hook and loop fasteners.

4: The inflatable massage backrest of claim 2, wherein the airbag is provided with an inflation nozzle; the inflation nozzle extends out of the backrest overlay from a surface of the backrest overlay facing towards the backrest covering cloth when the backrest overlay is in an in-use position.

5: The inflatable massage backrest of claim 2, further comprising a pillow; the pillow is detachably connected to an outer side of the backrest overlay.

6: The inflatable massage backrest of claim 1, wherein the airbag is fixedly disposed inside the backrest covering cloth.

7: The inflatable massage backrest of claim 6, wherein the airbag is provided with an inflation nozzle; the inflation nozzle extends outwardly out of an outer side of backrest covering cloth.

8: The inflatable massage backrest of claim 6, further comprising a pillow; the pillow is detachably connected to an outer side of the backrest covering cloth.

9: The inflatable massage backrest of claim 8, wherein the pillow is detachably connected to the outer side of the backrest covering cloth through hook and loop fasteners.

10: The inflatable massage backrest of claim 1, wherein the massager comprises a movable massage mechanism, at least one rail, and a massager housing; said at least one rail is fixed on the massager housing, and the movable massage mechanism is movably mounted on said at least one rail so as to be movable along an up-down direction of the massager; the movable massage mechanism is provided with a plurality of massage heads; surfaces of the plurality of massage heads where massage is applied are said massage surfaces.
